(19) United States
(12) Patent Application Publication
(10) Pub. No.: US 2013/0063814 A1
(43) Pub. Date: Mar. 14, 2013

(54) THREE DIMENSIONAL GLASSES

(71) Applicant: Hung-Yen HSIEH, Tu-Cheng (TW)

(72) Inventor: Hung-Yen HSIEH, Tu-Cheng (TW)

(73) Assignee: HON HAI PRECISION INDUSTRY CO., LTD., Tu-Cheng (TW)

(21) Appl. No.: 13/459,104

(22) Filed: Apr. 28, 2012

(30) Foreign Application Priority Data
Sep. 14, 2011 (TW) 100132945

(51) Int. Cl. G02B 27/22

(52) U.S. Cl. 359/464

(57) ABSTRACT

A pair of 3D glasses includes a pair of lenses, a circuit board, and a pair of electrical interlock pieces. Each lens has an electrical adjoining pad at an inner edge adjacent to a nosepiece of the 3D glasses. The electrical interlock pieces are positioned between the lenses and are coupled to the lenses and the circuit board.

### BACKGROUND

1. Technical Field

The disclosure is related to a pair of 3D glasses having simple structure.

2. Description of Related Art

Watching moving images in 3D has become commonplace. 3D technology relies on the viewer wearing a set of 3D glasses. There are two categories of 3D glasses, active and passive. Active 3D glasses operate independently to perform 3D stereo image effects, e.g. dual-display 3D glasses or liquid crystal shutter (ICS) 3D glasses. Current LCS 3D glasses are broadly configured for 3D entertainment. The LCS 3D glasses alternatively dim the right and then the left lenses in succession so that each eye of the viewer sees a slightly different angle of the same image to create 3D stereo effect. Active 3D glasses are driven by electricity to provide power and related signals for switching the lenses. A flexible circuit board is needed for receiving signals. Flexible circuit board of active 3D glasses may be coupled to the outside edges of the lenses (near the legs of 3D glasses). The flexible circuit board has to extend the electrical connection from the outside edge of one lens to the outside edge of another lens. In addition to an enlarged contact area, an increased thickness of the lenses is required to maintain a strong and inflexible structural connection between the lenses and the flexible circuit board. Therefore, the electrically conductive structure of the active 3D glasses of related art requires a larger and more intrusive flexible circuit board. The extension part of the flexible circuit is fragile and easily torn during transportation or assembly. Increased contact area necessitates an unequal thickness in the inner portion comparing to the outer portion. The difference in thickness weakens the strength of the lenses and makes the lenses vulnerable to damage if the 3D glasses are dropped. The configuration of the lenses of related art limits miniaturization of 3D glasses.

Therefore, it is desired to provide a pair of 3D glasses which can overcome the above-described limitations.

### BRIEF DESCRIPTION OF THE DRAWINGS

The components in the drawings are not necessarily drawn to scale, the emphasis instead being placed upon clearly illustrating the principles of an electrically conductive structure of a 3D glasses. Moreover, in the drawings, like reference numerals designate corresponding pans throughout the several views.

FIG. 1 is a diagram illustrating a pair of 3D glasses according to one embodiment, the 3D glasses including two lenses and a circuit board.

FIG. 2 is a diagram illustrating an electrically conductive structure between the lenses and the circuit board.

### DETAILED DESCRIPTION

Embodiments of the invention will be described with references to the accompanying diagrams.

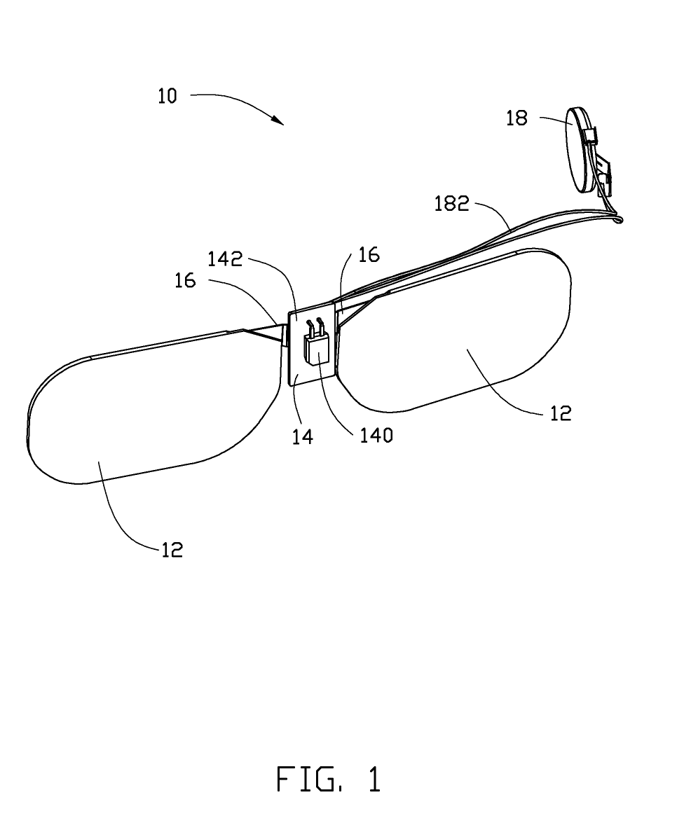

FIG. 1 is a diagram illustrating a pair of 3D glasses 10 according to one embodiment. The 3D glasses 10 include a pair of lenses 12, a circuit board 14, and a pair of electrical interlock pieces 16. The lenses 12 are symmetrically arranged and configured for being positioned on the right and left frames of an eyeglasses frame (not shown). A nosepiece is disposed and placed between the right and left frames so that the lenses 12 flank the nosepiece. When a viewer wears the 3D glasses, the nosepiece is disposed on viewer's nose and the lenses 12 are placed in front of viewer's eyes. Stereo images are switched alternatively by the lenses 12 to simulate a 3D display for the viewer. The circuit board 14 is disposed between the lenses 12 and connected to the lenses 12 by the electrical interlock pieces 16. The circuit board 14 comprises a flexible circuit board. Each electrical interlock piece 16 is coupled to the circuit board 14 at one end and coupled to a respective one of the lenses 12 at another end. The circuit board 14 has an outer surface 142 facing a 3D display device when the viewer wears the 3D glasses. An infrared receptor 140 is disposed on the outer surface 142. The infrared receptor 140 receives infrared signals from an infrared emitter (not shown) on the 3D display device. The infrared receptor 14 receives the infrared signals and transmits a control signal on the circuit board 14. The circuit board 14 has an inner surface 144 opposite to the outer surface 142. The electrical interlock pieces 16 are connected to two sides of the inner surface 144. The control signal is transmitted to the electrical interlock pieces 16 from the inner surface 144. The electrical interlock pieces 16 further transmit the control signal from the circuit board 14 to the lenses 12, and the lenses 12 are switched alternately according to the control signal provide a 3D stereo effect for the viewer. The 3D glasses 10 further includes a power device 18 coupled to the circuit board 14 via wires 182. The power device 18 is a battery to provide electricity to the circuit board 14.

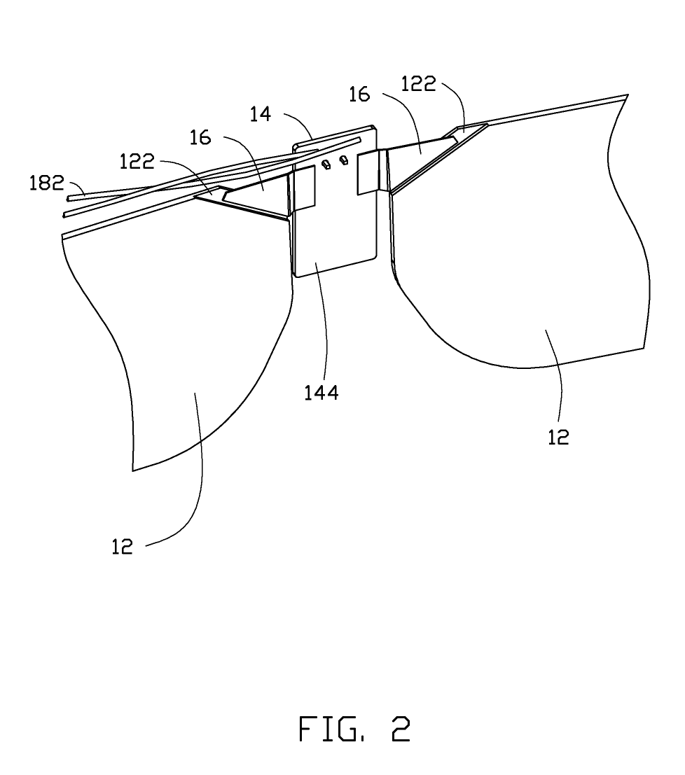

Material is removed from the thickness of each lens 12 at the upper and inner edge of each lens 12 so as to provide a flat and stepped surface. An electrical adjoining pad 122 is arranged on this flat and stepped surface of each lens 12 (see FIG. 2). Each of the electrical interlock pieces 16 is affixed to the electrical adjoining pad 122 and the lens 12 by way of a half lap joint, so as to provide a rigid, strong, and electrically conductive connection for the electrical interlock pieces 16. Each electrical adjoining pad 122 has a bevelled side surface and a major surface. The major surface of the electrical adjoining pad 122 is lower than the inner surface of the lens 12. In other words, the electrical adjoining pad 122 has a thickness less than the lens 12. The electrical interlock piece 16 has a major surface tightly adhered to the major surface of the electrical adjoining pad 122. The electrical interlock piece 16 has a bevelled side surface attached to the bevelled corner of the lens 12. In addition, the sum of the thickness of the electrical adjoining pad 122 and the thickness of the electrical interlock piece 16 is equal to or less than the thickness of the lens 12. The lenses 12 are close to the circuit board 14; therefore, the length of the electrical interlock pieces 16 is reduced, to lower manufacturing cost. To enhance the stability of the structure, the contact area between the electrical interlock pieces 16 and the circuit board 14 and the contact area between the electrical interlock pieces 16 and the lenses 12 may be enlarged by increasing the width of the electrical interlock pieces 16. The nature of the attachment between the lenses 12 and the circuit board 14 avoids any structurally weak points or peeling away of the electrical connections.

Furthermore, the circuit board 14 is placed in a space equal to the nosepiece between the lenses 12. The electrical interlock pieces 16 connect over a much shorter distance. The size of the contact area and the strength between the electrical interlock pieces 16 and the electrical adjoining pads 122 are enhanced. In addition to lowering manufacturing cost, the 3D glasses 10 prevent peeling by accidental tearing during assembly. The size of the 3D glasses 10 is reduced.

Although the present disclosure has been specifically described on the basis of this exemplary embodiment, the disclosure is not to be construed as being limited thereto. Various changes or modifications may be made to the embodiment without departing from the scope and spirit of the disclosure.

What is claimed is:

1. A pair of 3D glasses comprising:
a pair of lenses, each lens comprising an electrical adjoining pad at its inner edge;
a circuit board; and
a pair of electrical interlock pieces;
wherein each of the electrical adjoining pads is coupled to a respective one of the electrical interlock pieces, and the circuit board is placed between the electrical interlock pieces and coupled to the electrical interlock pieces.

2. The 3D glasses of claim 1, wherein each of the electrical adjoining pads has a surface lower than an inner surface of the respective lens.

3. The 3D glasses of claim 2, wherein each of the electrical adjoining pads has a thickness less than the respective lens.

4. The 3D glasses of claim 1, further comprising an infrared receptor disposed on an outer surface of the circuit board.

5. The 3D glasses of claim 4, wherein the circuit board has an inner surface opposite to the outer surface, and the inner surface of the circuit board is coupled to the electrical interlock pieces.

6. The 3D glasses of claim 1, further comprising a power device, which is coupled to the circuit board by wires.

7. The 3D glasses of claim 6, wherein the power device is a battery.

8. The 3D glasses of claim 1, wherein each of the electrical interlock pieces is positioned on the respective electrical adjoining pad and the respective lens by way of a half lap joint.
